(19) United States
(12) Patent Application Publication
(10) Pub. No.: US 2008/0155879 A1
(43) Pub. Date: Jul. 3, 2008

(54) Retrievable tether

(76) Inventors: J.D. Whipple, Napa, CA (US); Zachary Yates, Napa, CA (US)

Correspondence Address: Law Offices of Gerald L. Robertson & Assoc., 1110 Castle Oaks Drive, Napa, CA, 94558-1576, US

(21) Appl. No.: 11/649,695

(22) Filed: Jan. 3, 2007

(51) Int. Cl. A01M 31/06

(52) U.S. Cl. 43/3

(57) ABSTRACT

A tethering device comprising a spring-loaded reel inside an aerodynamic housing, said reel operated by closing or releasing a brake allowing the tethering line to be deployed or retrieved, said line having attached thereto and suitably wieghted anchor.

### FIELD OF THE INVENTION

The present invention deals with retrievable tethers. The instant invention is adapted in this application to a bouyed device such as a waterfowl decoy.

### STATEMENT REGARDING FEDERALLY-SPONSORED RESEARCH AND DEVELOPMENT

The present invention has not been developed as a result of any federally funded project, contract or any other situation in which governmental involvement including money, employees, contractors or other support has existed or continues.

### BACKGROUND OF THE INVENTION

For those who enjoy the outdoors, particularly hunting and fishing, part of the challenge for the outdoorsman is getting close enough to game to allow the game to be taken. For as long as time has been recorded, part of the strategy of hunters and fishermen has been to lure the game to them, as wild prey is far more adept at sensing moving humans and fleeing, than avoiding being taken when close to the skilled and technologically superior hunter or fisherman, In fishing, bait or artificial lures are used to attract game to the location of the fisherman. In hunting, and specifically, in the taking of waterfowl, native bird calls and decoys have evolved to a relatively sophisticated state in the efficient attraction of ducks, geese and others to within range of the sportsman.

In 1977, U.S. Pat. No. 4,056,890 was issued to Dembski, for a TETHERED DECOY, wherein a pawl and ratchet arrangement was operated to wind and unwind a tether line to an anchor. Reels for such use were further refined as shown in U.S. Pat. No. 4,340,192 issued to Burris, III Jul. 20, 1982. In the Burris reference, a more sophisticated scheme was employed to create a multiple hub, rotating reel.

Anchoring mechanisms continued to evolve in the field as evidenced by U.S. Pat. No. 4,757,630 issued to Torberg in 1988. The Torberg reference teaches a detachable reel and weighted handle mounted vertically using a pivoting cam and clamp assembly. By 1992, as disclosed in U.S. Pat. No. 5,168,650 issued to Martin, recoil style cords were employed for floating duck decoys.

The art gradually employed other features in combination with decoys such as in U.S. Pat. No. 5,461,816 issued to Gazalski, a device for winding the tether and removably storing the keel of the decoy while not in use. In 1999, in U.S. Pat. No. 5,941,008 issued to Schmidt, a vertically suspended weight was employed in the keel of the decoy to help it keep upright in the water. Attention to storing the anchor for a decoy continued to be a focus of the art as evidenced by U.S. Pat. No., 5, 992,078 issued to Willis, wherein an improved anchor storage mechanism is disclosed, including a cavity for such storage in the base of the decoy itself.

A more sophisticated yet patent issued in Dec. 3, 2002 as U.S. Pat. No. 6,487,811 B2, issued to Barrett, and included an anchor line wound on a reel and trained out of the body through a port in the breast of the body. A lock member was also disclosed for “snubbing” the anchor line between the lock member and the decoy body.

Attachable devices such as the “Decoy Retriever” marketed by PKI, Inc. have been marketed, said device comprising a block having a lockable and releasable cable which is retrievable, but such a device requires applying the device to a decoy with an adhesive, and provides no advantage to floatation or alignment of the decoy.

Recently, more attention has been paid to simple anchor methods and alignment of the decoys as disclosed in U.S. Pat. No. 6,543,176 B1 to McGhghy issued in April 2003, employing a basic anchor system of simple mechanical means, and U.S. Pat. No. 6,647,657 B2 issued to Igo for an adjustable decoy which varies the directional position of the decoy relative to the centerline of a traditional keel.

Of the references cited, none of them provide a simple, easy to use retrieval system which can be easily adjusted to position a decoy in the water and simply retrieve it.

The Burris III reference employs too complex a reel system which is too apt to be fouled by debris in the water, and which employs too complex a delivery and retrieval system which can increase production costs.

Likewise, Torberg and Schmidt et al. again disclose too many parts to make transport, setting up and retrieval of the decoys simple and unencumbered. In fact, with todays' extremely bouyant materials employed for construction of decoys, the weight of Schmidt et al. had been made obsolete by today's floating keels.

References like Gazalski, Martin and Willis are simple in operation, but do not provide a retrieval speed necessary for the sportsman who wishes to set a large number of decoys and pick them up in a short time at the end of the hunt.

Many of the disclosed devices such as the aforementioned Decoy Retriever also do not take into account the potential negative effect on the “natural” movement of the decoy in the water which can impact the attractiveness of the decoy to the wild waterfowl intended to be taken. Indeed, a product is presently on the market which constitutes a substantially rectangular and thick plastic block holding a spring-loaded wire, said block being permanently glued to a decoy, a preferred position not being particularly specified. Such a device would serve to alter the natural movement of the decoy to which it is attached by virtue of 1) the high resistivity of the device to oncoming water currents, and 2) its position on the decoy.

What is needed therefor is a simple device which can be easily deployed, economically manufactured, with as few complications and moving parts as possible, which allows natural movement of the decoy in the water, which is secure, and yet can still be used to rapidly retrieve a decoy in short time, minimizing storage problems associated therewith.

### SUMMARY OF THE INVENTION

It is an object of the present invention to provide a simple, effective mechanism for the rapid retrieval of a decoy. This is accomplished by providing a spring-loaded reel assembly inside a housing which allows for a manually applied brake for extending the tether itself for placement of the decoy and anchor, and when the brake is released, allowing the spring to retrieve the tether on the circumference of said reel.

It is a further object of the present invention to provide a device which does not restrict the movement of the decoy in the water in an unnatural fashion. By fashioning the housing for the spring-loaded reel assembly in an aerodynamic fashion, such that the water which would normally flow alongside the duck's breasts evenly continues to flow in the same way, the reel does not tend to bias the decoy to either the left or right direction.

The instant invention is also intended to adequately secure the decoy in position to maximize the attractiveness to wild game. By using an appropriate spring tension and weighted anchor, the device will hold a decoy in position to the hunter's satisfaction.

It is a further object of the present invention to provide a mechanism which can be adapted to existing decoys with ease. The instant invention can be removably fastened to the keel of a majority of the waterfowl decoys currently available, and can be adapted to fit into a receptacle inside a keel, be fixed or fastened therein, or could have as its housing, the keel structure itself.

Another object of the present invention is to allow replaceability of the mechanism due to its structural design and economical cost such that when inoperable after a sustained period of operation, a replacement may be economically justified, and easily substituted.

It is yet another object of the present invention to provide a mechanism which is simple enough in its design to be effective, yet economical to manufacture. The instant invention has essentially 6 primary parts of which only 3 move. The housing can be molded plastic, and no specially made parts are necessary for fabrication thereof. As will be shown below, the instant invention provides a simple, effective deployment and retrieval mechanism which is effective, economical and time-saving in its use.

### BRIEF DESCRIPTION OF THE DRAWINGS

FIG. 1 is a basic overview of the invention in use in a body of water, showing the basic orientation of the embodiment of the invention where the tether is mounting alongside the keel of a decoy.

FIG. 2 is a side view of the lower half of a decoy's keel showing the instant invention attached to the keel.

FIG. 3 is a frontal view of FIG. 2, showing the orientation of the device to the keel.

FIG. 4 is an isometric view of the device showing its general shape and the tether extended.

FIG. 5 is an exploded isometric view of the preferred embodiment wherein the various moving and non-moving parts of the device are shown.

FIG. 6A is a side view of a decoy's keel, showing in phantom a receptacle for receiving the invention.

FIG. 6B is the view shown in FIG. 6A with device 30 inserted therein.

FIG. 6C is a sectional view of FIG. 6A, showing device 30 affixed in said receptacle.

### DETAILED DESCRIPTION OF THE INVENTION

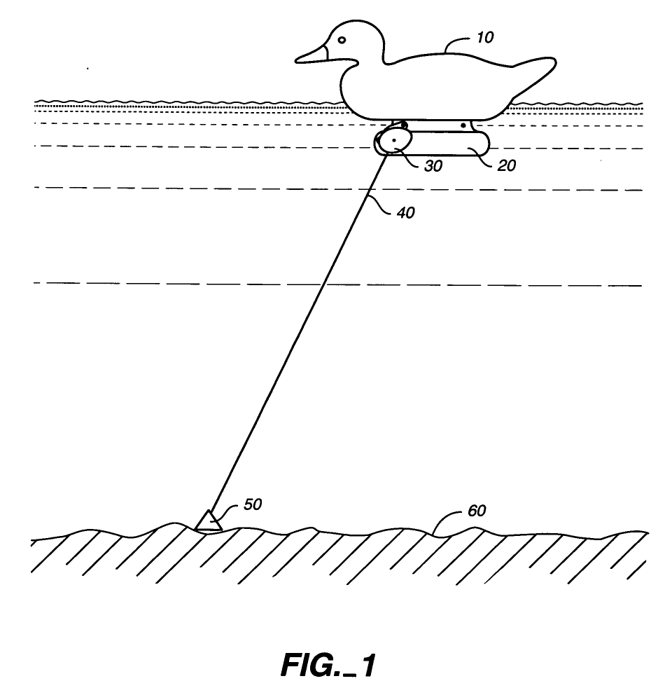

Referring to FIG. 1, waterfowl decoy 10 having a keel 20 is showing floating on a body of water. Device 30, an embodiment of the present invention, is attached to keel 20 and a line 40 extends therefrom with an anchor 50 attached, to secure decoy 10 in position relative to the lake bottom 60.

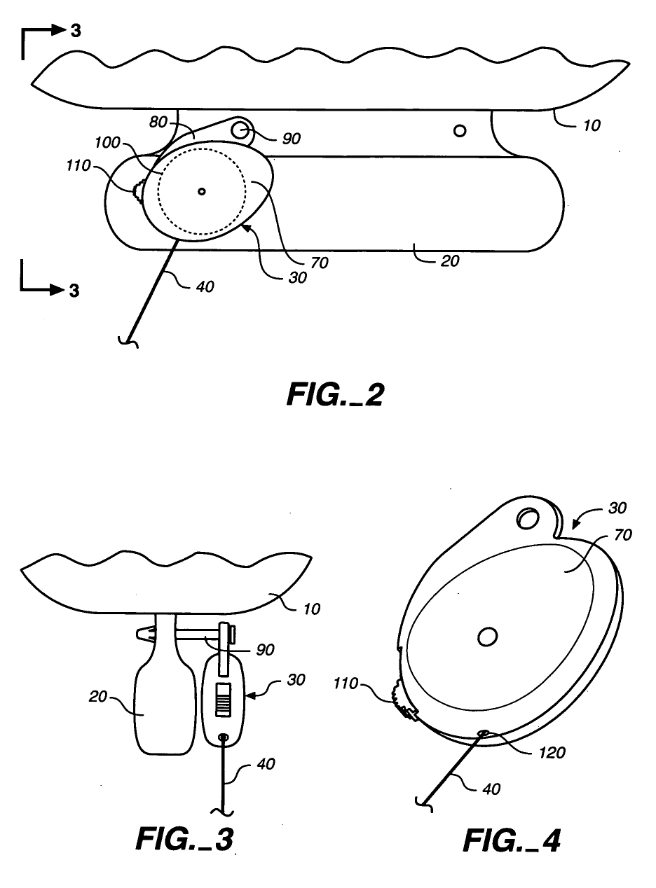

FIG. 2 shows device 30 positioned next to keel 20. Line 40 is shown extending from device 30. A housing 70, fashioned by assembling two concave halves, is provided with an ear 80 for mounting to keel 20. Fastening means 90 extends through ear 80 into keel 20 thereby positioning the device. Fastening means 90 may be any one of a number of devices including pins, rivets, nut and bolt, screw and any other removable fastening means which will hold the device securely and yet allow replacement of a substitute mechanism.

Inside housing 70, represented by a phantom line is reel 100. Reel 100 is operating by sliding brake 110 against a spring 140 (not shown).

Referring to FIG. 3, the positioning of device 30 is more readily seen, and in particular, fastening means 90, in this case a pin having a substantially conical shaped point and a head like that normally found on a nail.

FIG. 4 shows device 30, with substantially more definition. In this view, the ridged nature of brake 110 can be seen as well as orifice 120 defined by the closure of each half of housing 70, whereby line 40 may be deployed or retrieved with a minimum of debris allowed inside the device. A grommet 122 is snapped into place into orifice 120 when the device is assembled providing a smooth surface for tether 40 to pass through thereby eliminating grabbing or chafing by the split between the halves of housing 70. Also shown in this figure is a rivet 130 or the equivalent, which holds each half of housing 70 together, thereby capturing the internals of the device.

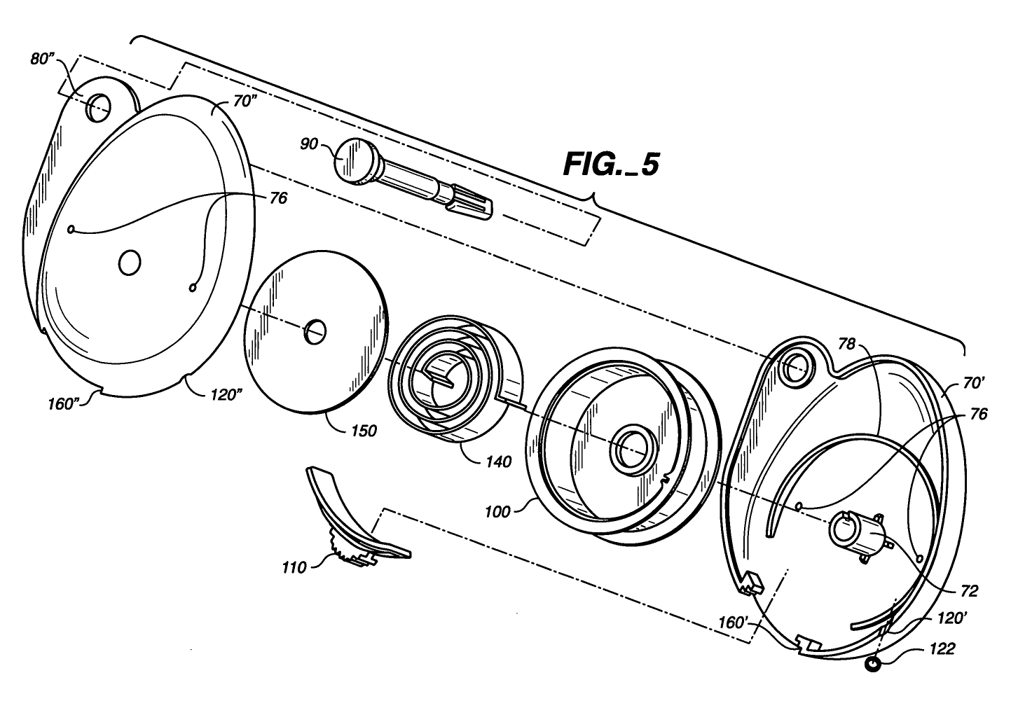

FIG. 5 shows the orientation of the internals of device 30. Housing 70 is comprised of two halves, 70′ and 70″, each being substantially concave in shape, thereby defining an interior and exterior of each half. Housing half 70′ has molded therein a slotted post 72 which is of male orientation and aligns proximate to an opening 74 in half 70″. When so located, a rivet, screw or other fastening means may be fixedly mounted into slotted post 72, thereby fastening said halves of said housing together, and enclosing the various parts therebetween. Each half of housing 70 is provided with at least one hole, 76 to allow water to enter and leave the housing thereby preventing unwanted bouyancy and also providing a means to drain the mechanism after use. Each half of housing 70 is further provided with a race 78 substantially concentric to said slotted post 72.

Reel 100 is located by slotted post 72 within each housing half's race 78, and also located in the interior periphery of reel 100 is a spring 140. Spring 140 is typically made of oil coated stainless steel approximately 8 millimeters thick, 15 millimeters wide and approximately 4 meters long. The interior end of spring 140 is received into slotted post 72, and further into a slot 102 located on the internal periphery of said reel. A spring plate 150 acts to retain tether 140 inside reel 100, said spring being held in position of compression or relaxation by brake 110. Brake 110 is slidably located inside a slot 160 defined by each half of said housing, shown as 160′ and 160″. Likewise, orifice 120 is defined in each half of said housing by hemi-orifices 120′ and 120″.

In this view, ear 80 is more fully disclosed, as is the configuration of fastener 90.

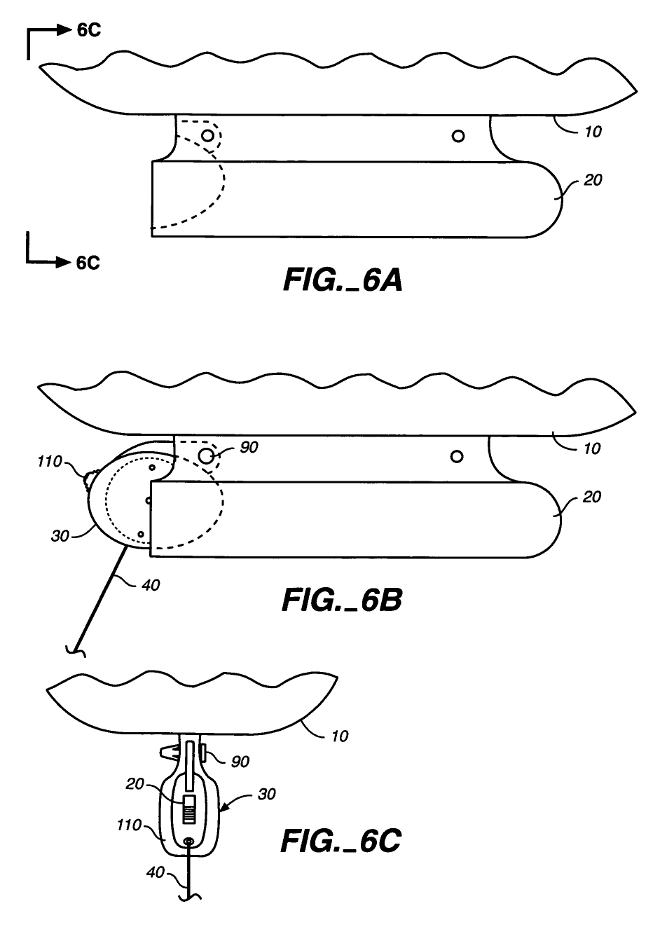

FIG. 6A shows in phantom line a receptacle in keel 20 of a decoy.

In FIG. 6B, device 30 is located in said receptacle and oriented such that line 40 plays out and may be deployed or retrieved by operating brake 110.

FIG. 6C shows device 30 inside the receptacle of FIG. 6A, and fastened by fastening means, or pin 90.

While the invention has been described in connection with what is presently considered the most practical and preferred embodiment(s), it is to be understood that the invention is not limited to the disclosed embodiment(s) but, on the contrary is intended to cover various modifications and equivalent arrangements included within the scope of the appended claims.

What is claimed is:

1. A retrievable tether comprising:
a housing, said housing further comprising two substantially concave halves defining an interior and exterior of each, said halves further provided with a hemispherical void in their periphery such that an exit hole is formed thereby;
one of said halves having molded therein a slotted post aligned proximate with an opening in said other half and capable of accepting a fastening means for securing said halves together;
said housing halves being provisioned with at least one hole to allow water to flow out or in said hole and a substantially rectangular peripheral opening stepped at each end;
each housing half further having a race provided therein substantially concentric to said slotted post;
a reel sized to be contained in said halves and concentric to said slotted post and said races, and contained thereby, said reel having;a slotted interior surface;
a coiled spring sized to fit inside said reel, said spring engaged in the slot of said slotted post and in said reel's slotted interior surface;
a spring plate having a hole in its center, said plate located in said halves and retaining said spring in said reel when said halves are joined;
a friction brake sized for acceptance in said stepped peripheral slot in said halves, said brake having a raised portion serrated to allow actuation by a user's finger, said brake positioned such that engagement with said reel is possible by means of said steps; and
a tether wound around said reel and exiting said halves through said exit hole, said tether capable of being connected to a weight and tensioned by means of said spring-reel assembly in said joined halves, said tether metered by use of said brake and retrievable by means of said spring when said brake is released.
